(19) United States
(12) Patent Application Publication
(10) Pub. No.: US 2026/0351022 A1
(43) Pub. Date: Nov. 5, 2026

(54) Processing an Image of Cereal Grain

(71) Applicant: AGCO International GmbH, Neuhausen (CH)

(72) Inventor: Dan Hermann, Randers (DK)

(21) Appl. No.: 19/115,540

(22) PCT Filed: Sep. 8, 2023
(86) PCT No.: PCT/IB2023/058914

§ 371 Date: Mar. 26, 2025

(30) Foreign Application Priority Data
Oct. 12, 2022 (GB) 2215018.9

(51) Int. Cl. G06V 20/68; G06V 10/26; G06V 10/82

(52) U.S. Cl. CPC G06V 20/68; G06V 10/26; G06V 10/82

(57) ABSTRACT

A mechanism for identifying non-cultivated or diseased kernels in an image. An image of harvested cereal grain is obtained and processed using one or more machine-learning methods to determine whether or not any such kernels are present. An indicator is output responsive to this determination.

### CROSS-REFERENCE TO RELATED APPLICATIONS

This application claims the benefit of International Patent Application PCT/IB2023/058914, “Processinq an lmaqe of Cereal Grain” filed Sep. 8, 2023, which claims the benefit of U. K. Provisional Patent Application 22150189, “Camera Based Detection and Mappinq of Wild Oats,” filed Oct. 12, 2022, the entire disclosure of which is incorporated herein by reference.

### FIELD OF THE INVENTION

Embodiments of the present disclosure generally relate to the field of combine harvesting.

### BACKGROUND OF THE INVENTION

With ever-increasing population numbers and ongoing interest in more environmentally friendly farming practices, there is an increasing desire to reduce waste when harvesting crop and improve the efficiency of harvesting machinery, such as combine harvesters.

It is becoming increasingly common for images of harvested crop to be analyzing during a harvesting process by a combine harvester. Typically, the images are analyzed to assess the effectiveness of the harvesting or to determine a quality of the harvested crop. For instance, existing image analysis techniques are used to monitor for cracked or insufficiently threshed material and/or the presence of material other than grain (MOG). This information could be used to modify the properties of the combine harvester in order to improve the quality of the harvested crop.

### SUMMARY OF THE INVENTION

The invention is defined by the claims.

According to examples in accordance with an aspect of the invention, there is provided a computer-implemented method of processing an image of harvested cereal grain.

The computer-implemented method comprises: obtaining the image of harvested cereal grain, the image depicting a plurality of kernels of the harvested cereal grain; processing the obtained image, using one or more machine-learning algorithms, to predict the presence or absence of any target kernels in the image, wherein a target kernel is a kernel of a non-cultivated cereal grain and/or a diseased kernel; and outputting an indicator that indicates the predicted presence or absence of any target kernels in the image.

The present disclosure proposes an approach for identifying non-cultivated or diseased kernels in an image of harvested grain. It has been herein recognized that non-cultivated or diseased kernels can be sufficiently distinguished from cultivated (i.e., desired or intended) kernels in an image for a machine-learning algorithm to identify the presence and/or absence of such non-cultivated/diseased kernels.

Harvested cereal grain is cereal grain that has undergone a harvesting process, e.g., to separate the kernels of the cereal crop from other parts of the cereal crop (i.e., to remove MOG). Typically, harvested cereal grain is produced by a combine harvester.

A non-cultivated cereal grain may be a grain from a non-cultivated strain or species of cereal grain, which can be called wild grain. Examples of non-cultivated cereal grain include wild oats, such as the common wild oat (Avena fatua) or slender wild oat (Avena barbata) or wild emmer (e.g., Triticum dicoccoides). A non-cultivated cereal grain may be otherwise labelled a weed cereal gain, and represents an undesired or unintended cereal grain that has been harvested and included in the harvested cereal grain.

A diseased kernel is a kernel carrying a disease or infection, such as a fungal infection.

The harvested cereal grain may, for instance, comprise: wheat, barley, oat or rye. It has been recognized that the size of these grains means that non-cultivated kernels can be distinguished from the cultivated or desirable kernels.

The indicator may, for instance, be an annotated image identifying the location of any target kernels in the image of harvested cereal grain. By way of example, each kernel in the image may be identified and associated with an annotation. Each annotation may provide a binary, categorical or numeric indicator or measure of a probability that each identified kernel is a target kernel.

In another example, the indicator may be a binary indicator that indicates a binary prediction of whether or not there are any target kernels in the image. In another example, the indicator is a numeric indicator indicating a probability that there are any target kernels in the image.

In some examples, the image of harvested cereal grain is an image of harvested cereal grain in a crop material stream (e.g., in a grain elevator) of a combine harvester. Other suitable locations for a crop material stream of harvested cereal grain within a combine harvester will be apparent to the skilled person.

The step of processing the obtained image may comprise: segmenting the obtained image using a first machine-learning algorithm to produced a segmented image that delineates a set of kernels depicted in the obtained image; and processing at least the segmented image using a second machine-learning algorithm to predict the presence of absence of any target kernels in the image.

The first machine-learning algorithm may be a convolutional neural network, preferably having a U-net architecture. Such machine-learning algorithms are particularly accurate at performing image segmentation, and therefore are advantageous to be used over other types of machine-learning algorithm.

The second machine-learning algorithm may be a decision tree algorithm. This provides a resource-efficient approach for identifying target kernels. This approach relies upon the recognition that segmented kernels in an image provide sufficient shape and/or structural detail to identify target kernels and that such target kernels are characterized by their shape/structure. This allows the use of decision tree algorithms that are able to process such characteristics in a resource-efficient manner.

Preferably, at least ten kernels depicted in the image have a pixel size of no less than 4 pixels by 4 pixels. This provides sufficient size for accurate discrimination between target and non-target kernels in the image.

Preferably, the image depicts no fewer than 50 kernels of cereal grain and/or no more than 200 kernels of cereal grain.

In some examples, the method comprises generating, at a user interface, a user-perceptible output in dependence on the indicator indicating the predicted presence of a target kernel in the image. This provides useful information for an operator in performing a technical task of assessing the condition of harvested grain and/or guiding future harvesting of grain.

In some preferred examples, each target kernel is a kernel of a non-cultivated cereal grain.

The computer-implemented method may further comprise obtaining a location indicator identifying a location at which the harvested grain was originally harvested; associating the location with the generated indicator; and recording the indicator and the associated location in a dataset. For the purposes of target grain treatment and/or future grain harvesting, it is useful or to identify locations at which any target kernels were harvested.

There is also proposed a computer-implemented method of generating a map illustrating locations of non-cultivated or diseased cereal grain.

The computer-implemented method comprises: iteratively performing the previously described method in which an indicator and associated location is stored in a dataset; and processing the dataset to generate a map indicating the location associated with each indicator that indicates the presence of any target kernel.

Preferably, the computer-implemented method is performed by a processor carried by a combine harvester.

There is proposed a computer program product comprising computer program code means which, when executed on a computing device having a processing system, cause the processing system to perform all of the steps of any previously described method.

There is also proposed a processing system for processing an image of harvested cereal grain. The processing system is configured to: obtain the image of harvested cereal grain, the image depicting a plurality of kernels of the harvested cereal grain; process the obtained image, using one or more machine-learning algorithms, to predict the presence or absence of any target kernels in the image, wherein a target kernel is a kernel of a non-cultivated cereal grain and/or a diseased kernel; and output an indicator that indicates the predicted presence or absence of any target kernels in the image.

The processing system may be configured to process the obtained image by: segmenting the obtained image using a first machine-learning algorithm to produce a segmented image that delineates a set of kernels depicted in the obtained image; and processing at least the segmented image using a second machine-learning algorithm to predict the presence of absence of any target kernels in the image.

These and other aspects of the invention will be apparent from and elucidated with reference to the embodiment(s) described hereinafter.

### BRIEF DESCRIPTION OF THE DRAWINGS

One or more embodiments of the invention/disclosure will now be described, by way of example only, with reference to the accompanying drawings, in which:

FIG. 1 illustrates a combine harvester;

FIG. 2 illustrates a design for a threshing unit for a combine harvester;

FIG. 3 conceptually illustrates a proposed approach;

FIG. 4 illustrates a proposed method;

FIG. 5 illustrates a processing system; and

FIG. 6 provides a more detailed view of the processing system.

### DETAILED DESCRIPTION OF THE EMBODIMENTS

The invention will be described with reference to the figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

The invention provides a mechanism for identifying non-cultivated or diseased kernels in an image. An image of harvested cereal grain is obtained and processed using one or more machine-learning methods to determine whether or not any such kernels are present.

An indicator is output responsive to this determination.

Embodiments are based on the realization that an image of harvested cereal grain contains sufficient information to distinguish target kernels (e.g., non-cultivated or diseased kernels) from non-target kernels. In particular, it has been recognized that the shape/structure of target kernels in such images is enough to discriminate between said target kernels and non-target kernels in an image containing a plurality of kernels.

Herein disclosed approaches can be employed in agricultural settings, and find particular use in the analysis of grain harvested by a combine harvester. In particular, disclosed approaches can be integrated into a combine harvester to

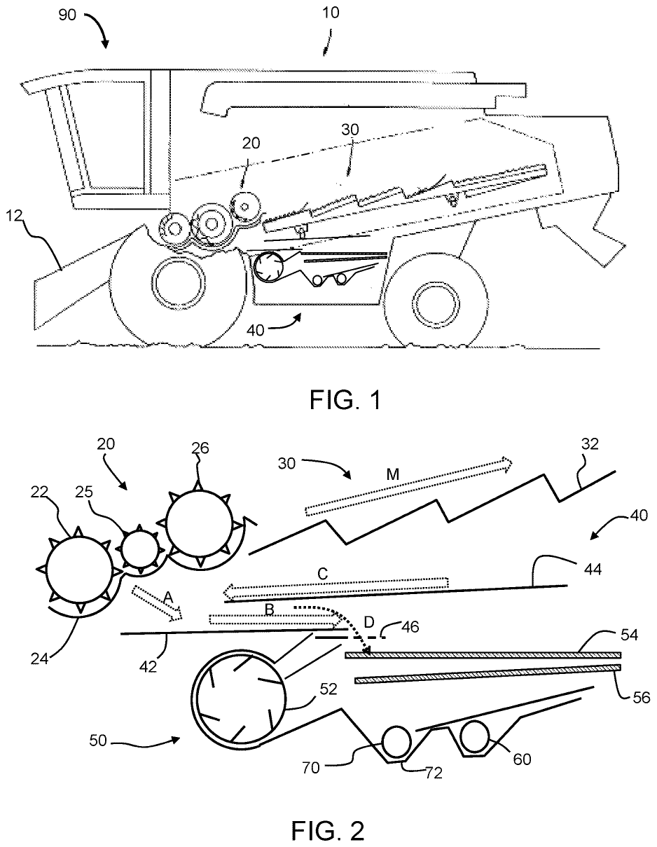

FIG. 1 conceptually illustrates a combine harvester 10, for improved contextual understanding.

FIG. 1 shows a known combine harvester 10 in which embodiments may be integrated. The combine harvester includes a threshing unit 20 for detaching grains of cereal from the ears of cereal, and a separating unit 30 which is connected downstream of the threshing unit 20. The grains after separation by the separating device 30 pass to a grain cleaning apparatus 40.

The combine harvester has a front elevator housing 12 at the front of the machine for attachment of a crop cutting head (known as the header, not shown). The header when attached serves to cut and collect the crop material as it progresses across the field, the collected crop stream being conveyed up through the elevator housing 12 into the threshing unit 20. In the example shown, the threshing unit 20 is a transverse threshing unit, i.e. formed by rotating elements with an axis of rotation in the side-to-side direction of the combine harvester and for generating a tangential flow.

The operation of the combine harvester may be controlled by a control system (not shown). The control system may receive input from a user interface and/or sensing apparatus and control the operation of the various units and apparatus responsive to the received input.

The combine harvester 10 may also comprise a user support 90, e.g. a cab, for housing an operator/individual. The user support will often contain a user interface to allow the operator/individual to influence or control the operation of the elements of the combine harvester (e.g. via the control system). The user interface may also provide information about the combine harvester and/or the status of the combine harvester.

The threshing unit 20, separating device 30 and grain cleaning apparatus 40 are shown in more detail in FIG. 2.

FIG. 2 shows one particular design for a threshing unit, namely a traverse threshing unit. The transverse threshing unit 20 includes a rotating, tangential-flow, threshing cylinder 22 and a concave-shaped grate 24, sometimes simply called a concave. The threshing cylinder 22 includes rasp bars (not shown) which act upon the crop stream to thresh the grain or seeds from the remaining material, the majority of the threshed grain passing through the underlying grate 24 and onto a stratification pan 42 (also known as the grain pan), which for convenience is in this disclosure considered to be part of the grain cleaning apparatus 40.

The threshing unit 20 also comprises a beater cylinder 25 (also with a transverse rotation axis and creating a tangential flow), downstream of the threshing cylinder and a tangential-flow multi-crop separator cylinder 26 (also with a transverse rotation axis and creating a tangential flow) downstream of the beater cylinder 25.

The threshing unit 20 shown in this example thus has a well-known set of three transversely mounted rollers and cylinders (otherwise known as drums). However, there are other transverse rotation (and hence tangential flow) threshing units. Typically, there is at least one threshing cylinder, and often also a beater cylinder.

The remainder of the crop material including straw, tailings and un-threshed grain are passed from the threshing unit 20 into the separating unit 30 as shown by arrow M.

In the example shown, the separating unit 30 includes a plurality of parallel, longitudinally-aligned, straw walkers 32, and this is suitable for the case of a so-called straw-walker combine. However, the separating unit 30 may instead include one or two longitudinally-aligned rotors which rotate about a longitudinal axis and convey the crop stream rearwardly in a ribbon passing along a spiral path. This is the case for a so-called axial or hybrid combine harvester.

In all cases, the separating unit 30 serves to separate further grain from the crop stream, and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 and separating unit 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 (i.e. a grain cleaning unit 50) is provided to remove this unwanted material thus leaving a clean sample of grain to be delivered to the tank.

For clarity, the term ‘grain cleaning apparatus’ is intended to include the stratification pan 42, the return pan 44 and other parts which form the grain cleaning unit 50 (also known as a cleaning shoe).

The grain cleaning unit 50 also comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing unit 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56.

It is known for chaffer 54 to include an inclined rear extension section (not shown), and MOG which reaches the rear section either passes over the rear edge and out of the machine or through the associated grate before being conveyed to a returns auger 60 for re-threshing in a known manner. The majority of materials passing through the rear end of the chaffer 54 is un-threshed tailings.

Grain passing through chaffer 54 is incident on the lower sieve 56 which is also driven in an oscillating manner and serves to remove tailings from the stream of grain before being conveyed to on-board tank or storage bin (not shown) via an augur 70 and a grain elevator (not shown). The auger resides in a transverse trough 72 at the bottom of the grain cleaning unit 50. Tailings blocked by sieve 56 are conveyed rearwardly by the oscillating motion thereof to a rear edge from where the tailings are directed to the tailings processing unit 60 or returns augur for reprocessing in a known manner.

The flow of material over the end of the stratification pan 42, shown as arrow D, is known as a cascade. It is desirable for this cascade to form a thin layer so that the airflow from the fan unit 52 is able to pass through the layer and lift the MOG away from the grains.

To assist this operation it is also known to have an additional cascade pan 46 between the stratification pan 42 and the chaffer 54. The grain and chaff then initially falls from the stratification pan 42 onto the cascade pan 46 before falling from the rear edge thereof onto the chaffer 54. The cascade pan 46 has a grid to convey long straw and weeds rearwardly and away from the cascading grain flow. The cascade pan assists the separation of grain from MOG.

In this case, fan unit 52 delivers a portion of a cleaning airstream rearwardly between the stratification pan 42 and the cascade pan 46 and another portion rearwardly between the chaffer 54 and the cascade pan 46, and between the sieves.

The fan unit 52 thus generates a cleaning air stream which is directed through the falling grain and chaff cascade. The fan 52 rotates on a transverse axis in a known manner and includes a plurality of impellor blades which draw in air from the transverse ends open to the environment and generate an air stream as explained above in a generally rearward direction. The air stream creates a pressure differential across the chaffer 54 and sieve 56 to encourage lighter MOG rearwardly and upwardly whilst allowing the grain to pass through the chaffer 54 and the sieve 56.

The operation of the various units and elements of the combine harvester may be controlled by a control unit (not shown). For instance, the control unit may modify one or more operational components of the combine harvester.

The present disclosure proposes an approach for processing an image of harvested cereal grain. The approach may, for instance, be used to process an image of cereal grain harvested by the combine harvester 10. In the context of the present invention, harvested grain preferably comprises grain that has been processed by a combine harvester to remove MOG, e.g., using the approach described above.

The proposed approach makes use of one or more machine-learning algorithms to predict the presence/absence of any target kernels in an image that depicts a plurality of harvested cereal grain kernels. A target kernel is a kernel of a non-cultivated cereal grain (e.g., a “wild” or “feral” cereal grain and/or a diseased kernel).

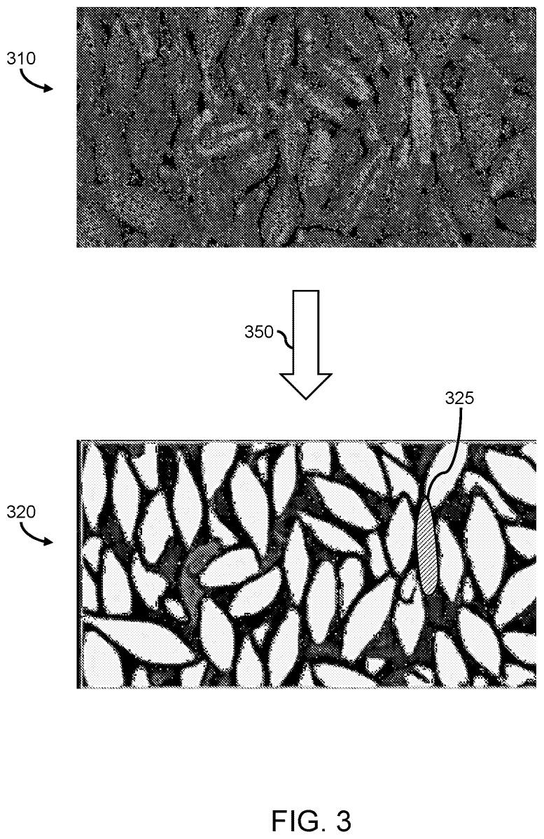

FIG. 3 conceptually illustrates the procedure according to proposed embodiments.

There is provided an image 310 of harvested cereal grain. The image 310 depicts a plurality of kernels of harvested cereal grain, e.g., grain held by an on-board tank of a combine harvester, in the grain elevator of a combine harvester or outside of a combine harvester (e.g., in a grain storage facility). The image can be taken with any suitable image capturing device, such as a camera.

The image 310 is processed in a process 350 using one or more machine-learning algorithms, to produce a processed image 320. The processed image 320 identifies (e.g. using shading or the like) the predicted presence/absence of any target kernels.

In the illustrated approach, process 350 comprises segmenting the image 310 to identify the location and/or shape of kernels in the image 310. Thus, an outline of each kernel is identified in the processed image 320. The segmented kernels are then processed using a machine-learning algorithm to identify any target kernels. In the illustrated example, a single target kernel 325 (here: a kernel of wild oat) has been identified.

The processed image 320 acts as an indicator that indicates the predicted presence or absence of any target kernels in the image. In particular, the processed image is an annotated image that identifies the location of any target kernels in the image of harvested cereal grain.

Other forms of indicator will be apparent to the skilled person. One example is a binary indicator that simply indicates whether or not (e.g., “1” or “0”) there are any target kernels predicted to be in the image. Another example is a numeric indicator that indicates a number of predicted target kernels in the image. Yet another example is a categorical indicator that indicators a predicted category (e.g., “Many”, “Few”, “None”) for a number of predicted target kernels in the image.

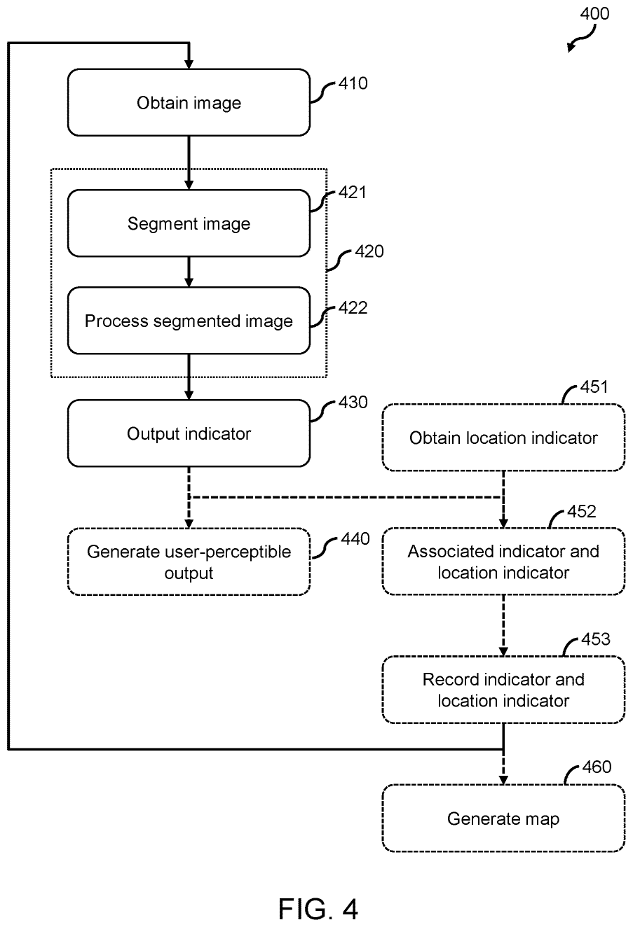

FIG. 4 illustrates a computer-implemented method 400 according to an embodiment. The computer-implemented method is for processing an image of harvested cereal grain.

The method 400 may, for instance, be performed by a processor carried by a combine harvester. As another example, the method 400 may be performed by a cloud-computing system.

The computer-implemented method comprises a step 410 of obtaining the image of harvested cereal grain, the image depicting a plurality of kernels of the harvested cereal grain.

The image may have been originally captured or generated by a camera, for instance, a camera taking an image of harvested cereal grain in a grain elevator or in an on-board tank of a combine harvester. This approach is particularly advantageous, as this makes it possible to provide immediate feedback to an operator of the combine harvester (e.g., to prevent the operator from continuing to harvest a contaminated region.

The image preferably depicts no fewer than 50 kernels of cereal grain and/or no more than 200 kernels of cereal grain. This provides an image with suitable numbers of kernels for efficient processing, without requiring significant amounts of processing power.

The computer-implemented method 400 then moves to a step 420 of processing the obtained image, using one or more machine-learning algorithms, to predict the presence or absence of any target kernels in the image. As previously explained, a target kernel is a kernel of a non-cultivated cereal grain and/or a diseased kernel.

One approach for performing step 420 has already been briefly described.

In particular step 420 may comprise a sub-step 421 of processing the image (obtained in step 410) using a first machine-learning algorithm to produce a segmented image. Thus, the image is input to the first machine-learning algorithm that produces, as an output, a segmented image. The segmented image delineates or outlines a set of kernels depicted in the obtained image.

The first machine-learning algorithm may a convolutional neural network, preferably having a U-net architecture. Such machine-learning algorithms are particularly efficient and accurate at performing image segmentation, and therefore are advantageous over other options for performing image segmentation.

Step 420 may then move to a sub-step 422 of processing at least the segmented image using a second machine-learning algorithm to predict the presence of absence of any target kernels in the image. This approach recognizes that the shape and/or structure of target kernels distinguishes said target kernels from other (more desirable) kernels. One particularly important recognition of the present invention is that it is possible to sufficiently distinguish desirable and undesirable (e.g., non-cultivated or diseased) kernels from one another from an image of the harvested grain alone.

In a similar manner, the segmented image is input to the second machine-learning algorithm that produces, as an output, information identifying the predicted presence or absence of any target kernels in the image.

The second machine-learning algorithm may be a decision tree algorithm. As another example, the second machine-learning algorithm may be a neural network. More generally, the second machine-learning algorithm may be any suitable classification or labelling algorithm.

Sub-step 422 may, for instance, comprise labelling each segmented kernel in the segmented image, identifying whether said segmented kernel is a target kernel or a non-target kernel. This produces a labelled image as the output of the second machine-learning algorithm.

This approach is particularly advantageous when the second machine-learning algorithm is a decision tree algorithm. This is because a decision tree algorithm can make use of shape and/or structural characteristics of each segmented kernel in order to determine or conclude whether each segmented kernel is a target kernel or not. Of course, other parameters of the segmented kernels could be used in processing the segmented kernel, such as the color or average color of the identified kernel (which information can be obtained from the original image).

As another example, step 420 may comprise processing the image using a single machine-learning algorithm configured to classify the image, e.g., as containing or not containing a target kernel. This can be performed directly and without necessitating the segmentation of the obtained image.

Yet other approaches for using one or more machine-learning algorithms to process an image to predict the presence or absence of any target kernels will be apparent to the skilled person.

The computer-implemented method 400 then moves to a step 430 of outputting an indicator that indicates the predicted presence or absence of any target kernels in the image.

The indicator may, for instance, be an annotated image identifying the location of any target kernels in the image of harvested cereal grain. By way of example, each kernel in the image may be identified and associated with an annotation. Alternatively, each annotation may provide a binary, categorical or numeric indicator or measure of a probability that each identified kernel is a target kernel.

The indicator may be an output of one or more of the machine-learning algorithms used in step 420, such as an annotated image or classification.

In other examples, the indicator 430 comprises data produced by further processing of an output of one or more of the machine-learning algorithms used in step 420. Thus, step 430 may comprise further process an output of a machine-learning algorithm used in step 420.

For instance, a machine-learning algorithm may output a segmented image identifying any target kernels in the segmented image, i.e., a labeled image. Step 430 may comprise counting the number of target kernels and providing, as the indicator, the number of target kernels in the segmented image.

As another example, a machine-learning algorithm may output a predicted number of target kernels in the image (or this can be produced using the above-described approach from a labelled segmented image). Step 430 may comprise comparing this predicted number to one or more predetermined thresholds to produce a categorical indicator of how many target kernels are in the image. For instance, a number above a first predetermined value may indicate that the number of target kernels is “Many”, a number between the first and a second predetermined value (lower than the first) may indicate that the number of target kernels is “Few”; and a number below the second predetermined value may indicate that the number of target kernels is “None”.

It will be appreciated that method 400 can be iteratively repeated, e.g., to repeatedly analyze different groups of cereal kernels.

It will be appreciated that, for the purposes of step 420, different sets of one or more machine-learning algorithms may be used to identify the presence or absence of different types of target kernel. For instance, a first set of one or more machine-learning algorithms may be used to predict the presence/absence of a first non-cultivated cereal grain. A second set of one or more one or more machine-learning algorithms may be used to predict the presence/absence of a second, different non-cultivated cereal grain. A third set of one or more one or more machine-learning algorithms may be used to predict the presence/absence of a kernel having a first disease/infection. A fourth set of one or more one or more machine-learning algorithms may be used to predict the presence/absence of a kernel having a second, different disease/infection.

Of course, any number or selection of such sets of one or more machine-learning algorithms can be used.

Accordingly, step 430 may correspondingly comprise outputting more than one indicator, e.g., an indicator for each set of one or more machine-learning algorithms.

Further optional features of method 400 are hereafter described.

The method 400 may further comprise further comprising a step 440 of generating, at a user interface, a user-perceptible output in dependence on (i.e., responsive to) the indicator indicating the predicted presence of a target kernel in the image. Approaches for controlling a user interface to provide a user-perceptible output are well known in the art. Example user-perceptible outputs include a visual output, an audible output and/or a haptic output.

As an example, step 440 may comprise controlling a display to provide a visual representation of the indicator. This may comprise, for instance, displaying how many target kernels have been identified in the image or displaying a segmented and labelled image.

As another example, step 440 may comprise controlling a speaker or buzzer to provide an audio output responsive to the indicator. For instance, a speaker or buzzer may generate a noise responsive to the indicator (output in step 430) indicating the presence of any target kernels, and remain silent otherwise.

As yet another example, step 440 may comprise controlling a light source responsive to the indicator. For instance, the light source may be controlled to generate light responsive to the indicator (output in step 430) indicating the presence of any target kernels, and not generate light otherwise.

Preferably, where the image is obtained in a combine harvester that harvests grain, the user interface for step 440 is in or at the user support (e.g., the cab) for the operator of the combine harvester. This allows the operator to take immediate responsive action to the detected presence of target kernels in the image.

If the method 400 is repeated a plurality of times, any user-perceptible output may be responsive to a plurality of indicators produced from the repetitions of method 400. For instance, the user-perceptible output may be responsive to more than a first predetermined number of indicator indicating the predicted presence of a target kernel in the image or more than a predetermined number of target kernels being detected across a second predetermined number of indicators (e.g., a 10 most recent indicators). Example user-perceptible outputs include a visual output, an audible output and/or a haptic output.

If more than one indicator is generated by steps 420, 430 (e.g., using a plurality of sets of one or more machine-learning algorithms), then step 440 may be appropriately modified to generate, at the user interface, a respective user-perceptible output for each indicator, each user-perceptible output being in dependence on (i.e., responsive to) the respective indicator.

For an operator of a combine harvester, it would be useful to identify a location at which any target kernels were harvested. This can be used, for instance, to guide future harvesting (e.g., to avoid this area) and/or treatment of the grain to be harvested.

Accordingly, method 400 may comprise a step 451 of obtaining a location indicator identifying a location at which the harvested grain was originally harvested; a step 452 of associating the location with the generated indicator; and a step 453 of recording the indicator and the associated location in a dataset.

A location indicator may, for instance, comprise a geolocation, e.g., a location derived from a satellite-based radionavigation system (e.g., a GPS® system or a Galileo navigation system). As another example, the location indicator may comprise a triangulated position, e.g., from radio or cellular towers.

It will be appreciated that a speed and/or path taken by the combine harvester since cutting the grain will cause the harvesting location to be different from the image capture location.

If the image obtained in step 410 was originally captured on a combine harvester, step 451 may comprise identifying a location at which the image was captured (e.g., using any previously mentioned approach) and a path taken by the combine harvester before the image was captured. The path may, for instance, be determined by tracking the location of the combine harvester. This information, together with knowledge on how long it takes harvested grain to move from the header of the combine harvester to the location at which the image is taken (which is known or determinable) can be used to identify the location at which the grain entered the combine harvester.

If the method 400 is iteratively repeated, then multiple indicators and corresponding location indicators will be stored in the dataset. The method 400 may then comprise a step 460 of processing the dataset to generate a map indicating the location associated with each indicator that indicates the presence of any target kernel.

In preferred examples, any may generated in step 460 is provided to an operator of the combine harvester, e.g., in a step 470. Thus, step 470 may comprise generating, at a user interface such as a display, a user-perceptible output in dependence on (i.e., responsive to) the generated map.

This approach provides useful information for an operator of the combine harvester.

It has previously been explained how one recognition is that the shape and/or structure of kernels in an image of harvested grain is sufficient to distinguish target kernels from non-target kernels. To improve the effectiveness of this, it is preferable that at least ten kernels depicted in the image have a pixel size of no less than 4 pixels by 4 pixels, e.g., no less than 10 pixels by 10 pixels. This ensures that the kernel(s) are depicted in sufficient detail to distinguish target and non-target kernels from one another.

The present invention provides techniques for identifying the presence of non-cultivated cereal in an image of harvested cereal grain. The precise identity of the non-cultivated cereal may depend upon the context in which the method is used, e.g., upon the identity of the desired crop or cereal grain. In particular, the non-cultivated cereal grain may be an undesired or unintended cereal grain (i.e., a cereal grain that is not intended to be grown in the relevant location). Examples of non-cultivated cereal grain include wild oats, such as the common wild oat (Avena fatua) or slender wild oat (Avena barbata) or wild emmer (e.g., Triticum dicoccoides). Other examples will be apparent to the skilled person.

The present invention provides techniques for identifying the presence of diseased kernels in an image of harvested cereal grain. Diseased kernels will have a different shape and/or structure to a non-diseased kernel. A diseased kernel may be any kernel affected by a fungal or bacterial infection.

Some embodiments of the invention make use of one or more machine-learning algorithms. Any suitable machine-learning algorithm may be used in different embodiments for the present disclosure. Suitable machine-learning algorithms include (artificial) neural networks, support vector machines (SVMs), Naïve Bayesian models and decision tree algorithms, although other appropriate examples will be apparent to the skilled person.

There are a number of well-established approaches for training a machine-learning algorithm. Typically, such training approaches make use of a large database of known input and output data. The machine-learning algorithm is modified until an error between predicted output data, obtained by processing the input data with the machine-learning algorithm, and the actual (known) output data is close to zero, i.e. until the predicted output data and the known output data converge. The value of this error is often defined by a cost function. The precise mechanism for modifying the machine-learning algorithm depends upon the type of model. Example approaches for use with a neural network include gradient descent, backpropagation algorithms and so on.

For the first machine-learning algorithm previously described, the known input data comprises example images. The corresponding known output data comprises, for each example image, a segmented image that delineates the kernel(s) depicted in the example image. The segmented images may be produced by an expert or trained individual (e.g., a biologist, botanist or phytologist).

For the second machine-learning algorithm previously described, the known input data comprises example segmented images. The corresponding known output data comprises, for each example segmented image, a labelled segmented image that identifies any target kernel(s) depicted in the example segmented image. The labelled segmented images may be produced by an expert or trained individual (e.g., a biologist, botanist or phytologist).

The skilled person will appreciate how different forms of known input and output data can be used dependent upon the function or purpose of the machine-learning algorithm.

For instance, if a machine-learning algorithm is to be trained to directly classify an image as containing or not containing one or more target kernels, then the known input data would comprise example images and the known output data would comprise a classification of each example image, which can be produced by an expert or trained individual (e.g., a biologist, botanist or phytologist).

Other modifications would be apparent to the skilled person.

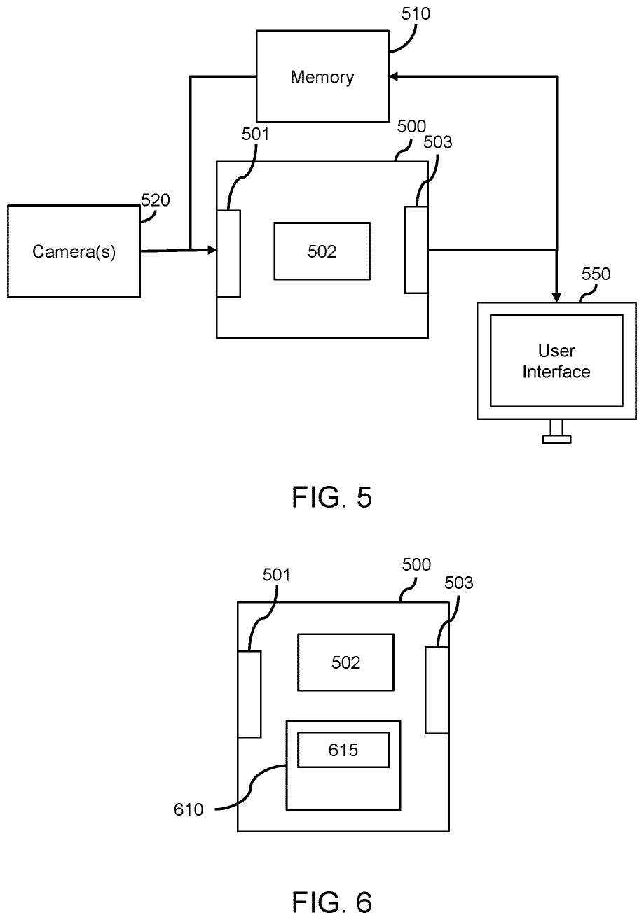

FIG. 5 illustrates a processing system 500 according to an embodiment. The processing system is configured to perform any herein described method 200.

The processing system 500 may thereby receive or obtain the image of harvested cereal grain, the image depicting a plurality of kernels of the harvested cereal grain. The processing system may receive these values from a memory or storage unit 510 and/or from one or more cameras 520.

The processing system 500 may comprise an input interface 501 configured to receive all of the above-identified data.

The processing system 500 is configured to process the obtained image, using one or more machine-learning algorithms, to predict the presence or absence of any target kernels in the image, wherein a target kernel is a kernel of a non-cultivated cereal grain and/or a diseased kernel. This process may be carried out by a processing unit 502 of the processing system 500.

The processing system 500 is configured to output an indicator that indicates the predicted presence or absence of any target kernels in the image. Any output of the processing system may be provided via an output interface 503. In particular, the output of the processing system may be defined by the processing unit 502 of the processing system via the processing unit.

In some examples, the indicator(s) is/are used to control a user interface 560, such as a display. This may be used, for instance, to provide at a user interface, a visual representation of any generated indicators.

In some examples, the indicator(s) is/are stored in the memory 510.

FIG. 6 illustrates an embodiment of the processing system 500 described with reference to FIG. 5. The processing system is able to carry out or perform one or more embodiments of an invention, e.g. for processing an image of harvested cereal grain.

The processing system 500 comprises an input interface 501 that receives communications from one or more inputting devices. Examples of suitable inputting devices include external memories, cameras and so on.

The processing system 500 also comprises a processing unit 502.

In one example, the processing unit 502 may comprise an appropriately programmed or configured single-purpose processing device. Examples may include appropriately programmed field-programmable gate arrays or complex programmable logic devices.

As another example, the processing unit may comprise a general purpose processing system (e.g. a general purpose processor or microprocessor) that executes a computer program 615 comprising code (e.g. instructions and/or software) carried by a memory 610 of the processing system 500.

The memory 610 may be formed from any suitable volatile or non-volatile computer storage element, e.g. FLASH memory, RAM, DRAM, SRAM, EPROM, PROM, CD-ROM and so on. Suitable memory architectures and types are well known to the person skilled in the art.

The computer program 615, e.g. the software, carried by the memory 610 may include comprise a sequence of instructions that are executable by the processing unit for implementing logical functions to carry out the desired method or procedure. Each instruction may represent a different logical function, step or sub-step used in performing a method or process according to an embodiment. The computer-program may be formed from a set of sub-programs, as would be known to the skilled person. The computer program 615 may be written in any suitable programming language that can be interpreted by the processing unit 502 for executing the instructions. Suitable programming languages are well known to the skilled person.

The processing system 500 also comprises an output interface 503. The processing system may be configured to provide information, such as the indicator(s), via the output interface. In some examples, the processing system may be configured to control one or more other devices connected to the output interface 503 by providing appropriate control signals to the one or more other devices. Suitable control examples include controlling a user-perceptible output such as a visual or audible representation (e.g. of the indicator) at a user interface.

Different components of the processing system 500 may interact or communicate with one another via one or more intra-system communication systems (not shown), which may include communication buses, wired interconnects, analogue electronics, wireless communication channels (e.g. the internet) and so on. Such intra-system communication systems would be well known to the skilled person.

It is not essential for the processing system 500 to be formed on a single device, e.g. a single computer. Rather, any of the system blocks (or parts of system blocks) of the illustrated processing system may be distributed across one or more computers.

The skilled person would be readily capable of developing a processing system for carrying out any herein described method. Thus, each step of the flow chart may represent a different action performed by a processing system, and may be performed by a respective module of the processing system.

It will be understood that disclosed methods are preferably computer-implemented methods. As such, there is also proposed the concept of a computer program comprising code means for implementing any described method when said program is run on a processing system, such as a computer. Thus, different portions, lines or blocks of code of a computer program according to an embodiment may be executed by a processing system or computer to perform any herein described method.

A computer program may be stored on a computer-readable medium, itself an embodiment of the invention. A “computer-readable medium” is any suitable mechanism or format that can store a program for later processing by a processing unit. The computer readable medium can be, for example but not limited to, an electronic, magnetic, optical, electromagnetic, infrared, or semiconductor system, apparatus or device. The computer-readable medium is preferably non-transitory.

In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa. Any reference signs in the claims should not be construed as limiting the scope.

All references cited herein are incorporated herein in their entireties. If there is a conflict between definitions herein and in an incorporated reference, the definition herein shall control.

1. A computer-implemented method of processing an image of harvested cereal grain, the computer-implemented method comprising:
obtaining the image of harvested cereal grain, the image depicting a plurality of kernels of the harvested cereal grain;
processing the obtained image, using one or more machine-learning algorithms, to predict the presence or absence of any target kernels in the image, wherein a target kernel is a kernel of a non-cultivated cereal grain and/or a diseased kernel; and
outputting an indicator that indicates the predicted presence or absence of any target kernels in the image.

2. The computer-implemented method of claim 1, wherein the image of harvested cereal grain is an image of harvested cereal grain from a crop material stream of a combine harvester.

3. The computer-implemented method of claim 1, wherein the step of processing the obtained image comprises:
segmenting the obtained image using a first machine-learning algorithm to produced a segmented image that delineates a set of kernels depicted in the obtained image; and
processing at least the segmented image using a second machine-learning algorithm to predict the presence of absence of any target kernels in the image.

4. The computer-implemented method of claim 3, wherein the first machine-learning algorithm is a convolutional neural network, preferably having a U-net architecture.

5. The computer-implemented method of claim 3, wherein the second machine-learning algorithm is a decision tree algorithm.

6. The computer-implemented method of claim 1, wherein at least ten kernels depicted in the image have a pixel size of no less than 4 pixels by 4 pixels.

7. The computer-implemented method of claim 1, wherein the image depicts no fewer than 50 kernels of cereal grain and/or no more than 200 kernels of cereal grain.

8. The computer-implemented method of claim 1, further comprising generating, at a user interface, a user-perceptible output in dependence on the indicator indicating the predicted presence of a target kernel in the image.

9. The computer-implemented method of claim 1, wherein each target kernel is a kernel of a non-cultivated cereal grain.

10. The computer-implemented method of claim 1, further comprising:
obtaining a location indicator identifying a location at which the harvested grain was originally harvested;
associating the location with the generated indicator; and
recording the indicator and the associated location in a dataset.

11. A computer-implemented method of generating a map illustrating locations of non-cultivated or diseased cereal grain, the computer-implemented method comprising:
iteratively performing the method of claim 10; and
processing the dataset to generate a map indicating the location associated with each indicator that indicates the presence of any target kernel.

12. The computer-implemented method of claim 1, wherein the computer-implemented method is performed by a processor carried by a combine harvester.

13. A computer program product comprising computer program code means which, when executed on a computing device having a processing system, cause the processing system to perform all of the steps of the method according to claim 1.

14. A processing system for processing an image of harvested cereal grain, the processing system being configured to:
obtain the image of harvested cereal grain, the image depicting a plurality of kernels of the harvested cereal grain;
process the obtained image, using one or more machine-learning algorithms, to predict the presence or absence of any target kernels in the image, wherein a target kernel is a kernel of a non-cultivated cereal grain and/or a diseased kernel; and
output an indicator that indicates the predicted presence or absence of any target kernels in the image.

15. The processing system of claim 14, wherein the processing system is configured to process the obtained image by:
segmenting the obtained image using a first machine-learning algorithm to produced a segmented image that delineates a set of kernels depicted in the obtained image; and
processing at least the segmented image using a second machine-learning algorithm to predict the presence of absence of any target kernels in the image.
